(19) United States
(12) Patent Application Publication
(10) Pub. No.: US 2010/0297535 A1
(43) Pub. Date: Nov. 25, 2010

(54) NOVEL DESIGN OF FUEL CELL BIPOLAR FOR OPTIMAL UNIFORM DELIVERY OF REACTANT GASES AND EFFICIENT WATER REMOVAL

(76) Inventors: Susanta K. Das, Grand Blanc, MI (US); Jayesh Kavathe, Flint, MI (US); Panini K. Kolavennu, Hillsboro, OR (US); K. Joel Berry, Flint, MI (US)

Correspondence Address: Jeremy J. Klobucar;Dickinson Wright PLLC, Ste. 2000, 38525 Woodward Ave.,, Bloomfield Hills, MI, 48304-2970, US

(21) Appl. No.: 12/783,949

(22) Filed: May 20, 2010

Related U.S. Application Data
(60) Provisional application No. 61/179,818, filed on May 20, 2009.

(51) Int. Cl. H01M 8/04

(52) U.S. Cl. 429/514

(57) ABSTRACT

The flow plate (20) defines stems (76), branches (78), and sub-branches (80) for moving fluid between each of the openings (34, 36) and the active area (42). The openings (34, 36) are trifurcated into two branches (78) and one stem (76) for providing flow of fluid through each of the stems (76) equal to the combined flow through co-diverging of the branches (78). The stems (76) have a minimal cross-sectional flow area less than the combined minimal cross-sectional flow area of the co-diverging of the branches (78). The stems (76) are bifurcated into two branches (78). The branches (78) have a uniform branch width (W_{B}) and are bifurcated into two sub-branches (80). The active area (42) includes manifolds (46, 48) and active channels (50, 52) extending therebetween. Each of the sub-branches (80) is in fluid communication with one of the manifolds (46, 48). Each of the manifolds (46, 48) is trifurcated into three active channels (50, 52) for evenly distributing fluid between the openings (34, 36) and the channels.

### CROSS REFERENCE TO RELATED APPLICATION

This application claims the benefit of application Ser. No. 61/179,818 filed May 20, 2009.

### BACKGROUND OF THE INVENTION

1. Field of the Invention

A flow plate for a fuel cell producing electrical current.

2. Description of the Prior Art

Flow plates for a fuel cell producing electrical current are well known in the prior art. U.S. Pat. No. 7,018,733 to Seguira, for example, includes a flow plate defining a plurality of openings and an active area for presenting fluid for reaction. U.S. Pat. No. 7,067,213 to Boff includes branches for moving fluid between the openings and the active area.

### SUMMARY OF THE INVENTION

At least one of said openings is trifurcated into two of the branches and one of the stems co-diverging therewith for providing flow of fluid through each of the stems equal to the combined flow through co-diverging of the branches.

### ADVANTAGES OF THE INVENTION

The present invention increases the velocity and uniformity of fluid flow through the flow plate to improve reaction rates and remove water therefrom.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a front view of a flow plate according to the present invention;

FIG. 2 is a rear view of a flow plate according to the present invention; and

FIG. 3 is a perspective view of a flow plate according to the present invention.

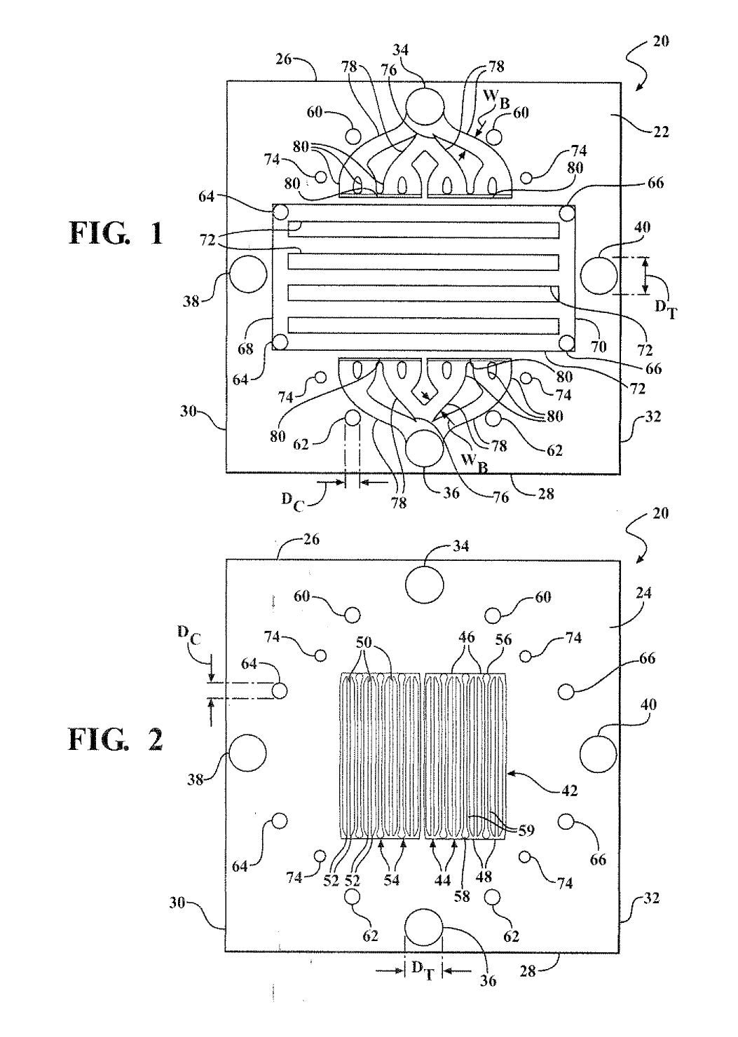

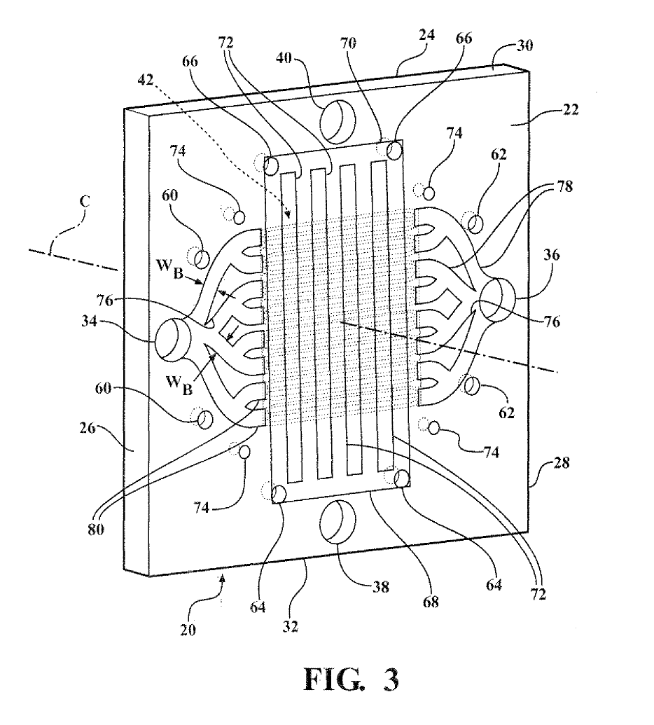

### DETAILED DESCRIPTION OF THE INVENTION

Referring to the Figures, wherein like numerals indicate corresponding parts throughout the several views, a fuel cell flow plate 20 defining a collector face 22 and a membrane face 24 parallel to the collector face 22. The flow plate 20 has an inlet edge 26 and an outlet edge 28 parallel to the inlet edge 26. The outlet edge 28 and the inlet edge 26 are interconnected by a first bypass edge 30 perpendicular to the inlet edge 26 and the outlet edge 28 and a second bypass edge 32 parallel to the first bypass edge 30 to define a square perimeter. The flow plate 20 defines a center axis C extending centrally therethrough and perpendicular to the membrane face 24 and the collector face 22.

The flow plate 20 defines two openings 34, 36 and two bypass holes 38, 40 extending perpendicular to the membrane face 24 and the collector face 22. Each of the openings 34, 36 and the bypass holes 38, 40 has a pass-through diameter D_{T} and the pass-through diameters D_{T} are equal. Each of the openings 34, 36 and the bypass holes 38, 40 are spaced inwardly from a different one of the edges 26, 28, 30, 32 by an equal distance.

The openings 34, 36 include an inlet opening 34 adjacent and inward from the inlet edge 26 and midway between the first bypass edge 30 and the second bypass edge 32. The openings 34, 36 include an outlet opening 36 radially opposite the inlet opening 34 and adjacent and inward from the outlet edge 28 and midway between the first bypass edge 30 and the second bypass edge 32. The bypass holes 38, 40 including a first bypass hole 38 adjacent and inward from the first bypass edge 30 and midway between the inlet edge 26 and the outlet edge 28 and disposed ninety degrees from the inlet opening 34 about the center axis C. The bypass holes 38, 40 include a second bypass hole 40 radially opposite the first bypass hole 38 and adjacent and inward from the second bypass edge 32 and midway between the inlet edge 26 and the outlet edge 28.

The membrane face 24 defines an active area 42 for presenting fluid for reaction. The active area 42 includes a plurality of channel sets 44 each including an inlet-side manifold 46 and an outlet-side manifold 48 and a plurality of the active channels 50, 52 interconnecting the manifolds 46, 48. The membrane face 24 presents a plurality of ribs 54 each disposed between two adjacent of the channel sets 44 with each rib 54 defining an inlet head 56 and an outlet head 58 and each of the heads 56, 58 being bulbous and interconnected by a straight section 59 parallel to the first bypass edge 30.

The flow plate 20 defines a plurality of coolant holes 62, 64, 66, 60 extending therethrough perpendicular to the membrane and collector faces 24, 22. The coolant holes 62, 64, 66, 60 have coolant hole diameters D_{C} being equal. The coolant holes 62, 64, 66, 60 include two inlet-side coolant holes 60 inward from and on either side of the inlet opening 34 and a pair of outlet-side coolant holes 62 inward from and on either side of the outlet opening 36. The coolant holes 62, 64, 66, 60 include two first bypass-side coolant holes 64 inward from and on either side of the first bypass hole 38 and two second bypass-side coolant holes 66 inward from and on either side of the second bypass hole 40.

The collector face 22 defines a plurality of cooling channels 68, 70, 72 overlapping the active channels 50, 52 of the membrane face 24. The cooling channels 68, 70, 72 include a first bypass-side cooling channel 68 extending between the first bypass-side coolant holes 64 and parallel to the first bypass edge 30. The cooling channels 68, 70, 72 including a second bypass-side cooling channel 70 extending between the second bypass-side coolant holes 66 and parallel to the first bypass-side cooling channel 68. The cooling channels 68, 70, 72 include a plurality of transverse cooling channels 72 extending perpendicular to and between the first bypass-side cooling channel 68 and the second bypass-side cooling channel 70.

The flow plate 20 defines a plurality of alignment holes 74 extending therethrough perpendicular to the collector and membrane faces 22, 24. One of the alignment holes 74 is between the inlet opening 34 and the second bypass hole 40. One other of the alignment holes 74 is between the second bypass hole 40 and the outlet opening 36. One other of the alignment holes 74 is between the outlet opening 36 and the first bypass hole 38. One other of the alignment holes 74 is between the first bypass hole 38 and the inlet opening 34,

The flow plate 20 is one of an anode flow plate 20 for presenting hydrogen for reaction and a cathode flow plate 20 for presenting oxygen for reaction.

The flow plate 20 defines a plurality of stems 76 and a plurality of branches 78 and a plurality of sub-branches 80 each extending arcuately and for moving fluid between each of said openings 34, 36 and said active area 42.

Each of the openings 34, 36 is trifurcated into two of the branches 78 and one of the stems 76 co-diverging therewith and between the co-diverging of the branches 78 for providing flow of fluid through each of the stems 76 equal to the combined flow through of co-diverging of the branches 78. Each of the stems 76 have a minimal cross-sectional flow area less than the combined minimal cross-sectional flow area of the co-diverging of the branches 78. Each of the stems 76 is bifurcated into two of the branches 78. Each of the branches 78 has a uniform branch width W_{B} and is bifurcated into two sub-branches 80. Each of the sub-branches 80 is in fluid communication with one of the manifolds 46, 48 of one of the channel sets 44. Each of the manifolds 46, 48 is trifurcated into three of the active channels 50, 52 for evenly distributing fluid from the inlet into each of the active channels 50, 52 with uniform velocity and pressure drop and for collecting fluid from each of the active channels 50, 52 into the outlet opening 36 with uniform velocity and pressure drop.

The flow plate 20 defines a plurality of slots 82 each interconnecting adjacent of the sub-branches 80. One of the slots 82 is adjacent each of the heads 56, 58. In an embodiment, the membrane face 24 defines the stems 76, the branches 78, and the sub-branches 80. In another embodiment, the collector face 22 defines the stems 76, the branches 78, and the sub-branches 80.

Each of the channel sets 44 including a middle active channel 50 extending perpendicular to the inlet edge 26 and a pair of diverging active channels 52 disposed adjacent the middle active channel 50 and diverging in opposite directions from the middle active channel 50 and the inlet-side manifold 46 and then extending parallel with the middle active channel 50 and converging into the outlet-side manifold 48 with the middle active channel 50.

Obviously, many modifications and variations of the present invention are possible in light of the above teachings and may be practiced otherwise than as specifically described while within the scope of the appended claims. The use of the word “the” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. A fuel cell flow plate (20) comprising:
said flow plate (20) defining a plurality of openings (34, 36) and an active area (42) for presenting fluid for reaction and a plurality of branches (78) and a plurality of stems (76) for moving fluid between said openings (34, 36) and said active area (42), and
at least one of said openings (34, 36) being trifurcated into two of said branches (78) and one of said stems (76) co-diverging therewith for providing flow of fluid through each of said stems (76) equal to the combined flow through co-diverging of said branches (78).

2. A fuel cell flow plate (20) as set forth in claim 1 wherein each of said stems (76) has a minimal cross-sectional flow area less than the combined minimal cross-sectional flow area of co-diverging of said branches (78) more novelty details exist.

3. A fuel cell flow plate (20) as set forth in claim 1 wherein each of said sterns (76) are between co-diverging of said branches (78).

4. A fuel cell flow plate (20) as set forth in claim 1 wherein each of said stems (76) are bifurcated into two of said branches (78) for evenly moving fluid between trifurcated of said openings (34, 36) and said branches (78) with uniform velocity and pressure drop.

5. A fuel cell flow plate (20) as set forth in claim 4 wherein each of said branches (78) have an equal branch width (W_{B}).

6. A fuel cell flow plate (20) as set forth in claim 4 wherein each of said branches (78) are bifurcated into two sub-branches (80) extending arcuately for evenly moving fluid between said branches (78) and said sub-branches (80) with uniform velocity and pressure drop.

7. A fuel cell flow plate (20) as set forth in claim 6 wherein said flow plate (20) defines a plurality of slots (82) each interconnecting adjacent of said sub-branches (80).

8. A fuel cell flow plate (20) as set forth in claim 6 wherein said active area (42) includes a plurality of channel sets (44) each including an inlet-side manifold (46) and an outlet-side manifold (48) and a plurality of said active channels (50, 52) interconnecting said manifolds (46, 48).

9. A fuel cell flow plate (20) as set forth in claim 8 wherein each of said sub-branches (80) are in fluid communication with one of said manifolds (46, 48) of one of said channel sets (44).

10. A fuel cell flow plate (20) as set forth in claim 9 wherein each of said manifolds (46, 48) are trifurcated into three of said active channels (50, 52) for evenly moving fluid from between said sub-branches (80) and said active channels (50, 52) with uniform velocity and pressure drop.

11. A fuel cell flow plate (20) as set forth in claim 10 wherein each of said channel sets (44) include a middle active channel (50) and a pair of diverging active channels (52) disposed adjacent said middle active channel (50) and diverging in opposite directions from said middle active channel (50) and said inlet-side manifold (46) and then extending parallel with said middle active channel (50) and converging into said outlet-side manifold (48) with said middle active channel (50).

12. A fuel cell flow plate (20) as set forth in claim 10 wherein said flow plate (20) defines a collector face (22) and a membrane face (24) parallel to said collector face (22) and has an inlet edge (26) and an outlet edge (28) parallel to said inlet edge (26) and interconnected by a first bypass edge (30) perpendicular to said inlet edge (26) and said outlet edge (28) and a second bypass edge (32) parallel to said first bypass edge (30) to define a square perimeter and said flow plate (20) defines a center axis (C) extending centrally therethrough and perpendicular to said membrane face (24) and said collector face (22).

13. A fuel cell flow plate (20) as set forth in claim 12 wherein said flow plate (20) defines two said openings (34, 36) and two bypass holes (38, 40) extending perpendicular to said membrane face (24) and said collector face (22) and each have pass-through diameters (D_{T}) being equal and each being radially spaced inwardly from a different one of said edges (26, 28, 30, 32) by an equal distance and said openings (34, 36) including an inlet opening (34) adjacent and inward from said inlet edge (26) and midway between said first bypass edge (30) and said second bypass edge (32) and said openings (34, 36) including an outlet opening (36) radially opposite said inlet opening (34) and adjacent and inward from said outlet edge (28) and midway between said first bypass edge (30) and said second bypass edge (32) and said bypass holes (38, 40) include a first bypass hole (38) adjacent and inward from said first bypass edge (30) and midway between said inlet edge (26) and said outlet edge (28) and disposed ninety degrees from said inlet opening (34) about said center axis (C) and said bypass holes (38, 40) include a second bypass hole (40) radially opposite said first bypass hole (38) and adjacent and inward from said second bypass edge (32) and midway between said inlet edge (26) and said outlet edge (28).

14. A fuel cell flow plate (20) as set forth in claim 12 wherein said membrane face (24) defines said active channels (50, 52) and said membrane face (24) presents a plurality of ribs (54) each disposed between two adjacent of said channel sets (44) with each rib (54) defining an inlet head (56) and an outlet head (58) and each of said heads (56, 58) being bulbous and interconnected by a straight section parallel (59) to said first bypass edge (30) and one of said slots (82) being adjacent each of said heads (56, 58).

15. A fuel cell flow plate (20) as set forth in claim 13 wherein said flow plate (20) defines a plurality of alignment holes (74) extending therethrough perpendicular to said collector and membrane faces (22, 24) and one of said alignment holes (74) being between said inlet opening (34) and said second bypass hole (40) and one other of said alignment holes (74) being between said second bypass hole (40) and said outlet opening (36) and one other of said alignment holes (74) being between said outlet opening (36) and said first bypass hole (38) and a one other of said alignment holes (74) being between said first bypass hole (38) and said inlet opening (34).

16. A fuel cell flow plate (20) as set forth in claim 13 wherein said flow plate (20) defines a plurality of coolant holes (62, 64, 66, 60) extending therethrough perpendicular to said membrane and collector faces (24, 22) and having coolant hole diameters (D_{C}) being equal and said coolant holes (62, 64, 66, 60) include two inlet-side coolant holes (60) inward from and on either side of said inlet opening (34) and a pair of outlet-side coolant holes (62) inward from and on either side of said outlet opening (36) and two first bypass-side coolant holes (64) inward from and on either side of said first bypass hole (38) and two second bypass-side coolant holes (66) inward from and on either side of said second bypass hole (40).

17. A fuel cell flow plate (20) as set forth in claim 16 wherein said collector face (22) defines a plurality of cooling channels (68, 70, 72) overlapping said active channels (50, 52) of said membrane face (24) and said cooling channels (68, 70, 72) include a first bypass-side cooling channel (68) extending between said first bypass-side coolant holes (64) and parallel to said first bypass edge (30) and said cooling channels (68, 70, 72) include a second bypass-side cooling channel (70) extending between said second bypass-side coolant holes (66) and parallel to said first bypass-side cooling channel (68) and said cooling channels (68, 70, 72) include a plurality of transverse cooling channels (72) extending perpendicular to and between said first bypass-side cooling channel (68) and said second bypass-side cooling channel (70).

18. A fuel cell flow plate (20) as set forth in claim 12 wherein said collector face (22) defines said stems (76) and said branches (78) and said sub-branches (80).

19. A fuel cell flow plate (20) as set forth in claim 12 wherein said membrane face (24) defines said stems (76) and said branches (78) and said sub-branches (80).

20. A fuel cell flow plate (20) as set forth in claim 1 wherein said flow plate (20) is one of an anode flow plate (20) for presenting hydrogen for reaction and a cathode flow plate (20) for presenting oxygen for reaction.

21. A fuel cell flow plate (20) as set forth in claim 1 wherein said branches (78) and said stems (76) extend arcuately from said openings (34, 36).
